(19) United States
(12) Patent Application Publication
(10) Pub. No.: US 2013/0156030 A1
(43) Pub. Date: Jun. 20, 2013

(54) RAPID DISSEMINATION OF INFORMATION TO WIDELY DISPERSED NETWORK NODES VIA PATCH

(71) Applicants: Jeremy Johnson, Redwood City, CA (US); Raj Vaswani, Redwood City, CA (US); Kunal Shah, Redwood City, CA (US)

(72) Inventors: Jeremy Johnson, Redwood City, CA (US); Raj Vaswani, Redwood City, CA (US); Kunal Shah, Redwood City, CA (US)

(21) Appl. No.: 13/327,815

(22) Filed: Dec. 16, 2011

(51) Int. Cl. H04L 12/56

(52) U.S. Cl. 370/390

(57) ABSTRACT

A method of distributing information to a plurality of nodes in a network. The method includes selecting a node of the plurality of nodes as a seed node, providing a patch image to the seed node, creating, by the seed node, a second image from the patch image, and disseminating the second image to a plurality of neighbor nodes.

### BACKGROUND

The invention relates to the rapid dissemination of information to widely dispersed nodes on a network. More specifically, the invention relates to using a patch method to rapidly disseminate information to widely dispersed nodes on a network.

The transfer of information such as firmware/software downloads and upgrades is practiced widely in communications networks, where a central server transmits information to nodes in the network via broadcast or unicast messages transmitted on a scheduled or unscheduled basis. A network node can also request a download at any time. In one technique, communication sessions are set up in a point-to-point mode or a point-to-multipoint mode to facilitate the transfer of information.

In networks with limited bandwidth and/or a large number of widely dispersed nodes, unicast methods can be punitive in terms of bandwidth and network resources, since a separate message is sent to each node. The broadcast mode can be more efficient, but can tie up the network for a considerable period of time, since all nodes typically have to listen to the central node at the same time in order to receive the desired information. The transfer of information to each requesting node may demand considerable time and bandwidth resources, possibly disrupting normal network operations.

Based at least in part upon these and other limitations of existing methods for transfer of information to nodes in a network, new systems and methods for such transfer of information are welcome additions to the art.

### SUMMARY

In one embodiment, the invention provides a method of distributing information to a plurality of nodes in a network. The method includes selecting a node of the plurality of nodes as a seed node, providing a patch image to the seed node, creating, by the seed node, a second image from the patch image, and disseminating the second image to a plurality of neighbor nodes.

In another embodiment, the invention provides a method of distributing information to a plurality of nodes in a network. The method includes receiving a first patch image by a first node of the plurality of nodes, the first node having a first firmware type, building, by the first node, a first complete image using the first patch image, informing the plurality of nodes that the first complete image is available, receiving a request for the first complete image from another of the plurality of nodes, and sending the first complete image from the first node to the node which requested the first complete image.

In a further embodiment, the invention provides a method of updating a network having nodes with two or more incompatible firmware types. The method includes selecting a first node in the network having a first firmware-type as a first seed node, selecting a second node in the network having a second firmware-type as a second seed node, providing a first firmware-type patch image to the first node, providing a second-firmware-type patch image to the second node, recreating, by the first node, a first firmware-type complete image, recreating, by the second node, a second firmware-type complete image, disseminating, by the first node, the first firmware-type complete image to a first plurality of nodes on the network having the first firmware-type, and disseminating, by the second node, the second firmware-type complete image to a second plurality of nodes on the network having the second firmware-type.

Other aspects of the invention will become apparent by consideration of the detailed description and accompanying drawings.

### BRIEF DESCRIPTION OF THE DRAWINGS

FIG. 1 is a schematic diagram of a first network configuration.

FIG. 2 is a schematic diagram of a second network configuration.

FIGS. 3a and 3b depict two phases of a bulk information transfer to nodes of an exemplary network.

FIG. 4 is a flow chart of a back office system process for updating nodes on a network.

FIG. 5 is a flow chart of a seed node process for updating nodes on a network.

FIG. 6 is a flow chart of a node process for updating nodes on a network.

FIG. 7 is a flow chart of a process for updating nodes on a network.

### DETAILED DESCRIPTION

Before any embodiments of the present invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

U.S. Pat. No. 7,961,741 (the '741 Patent), filed Oct. 23, 2008, issued Jun. 14, 2011, and entitled “Rapid Dissemination of Bulk Information to Widely Dispersed Network Nodes,” the entire contents of which are hereby incorporated by reference, discloses methods for disseminating images to widely dispersed nodes on one or more networks using seeding.

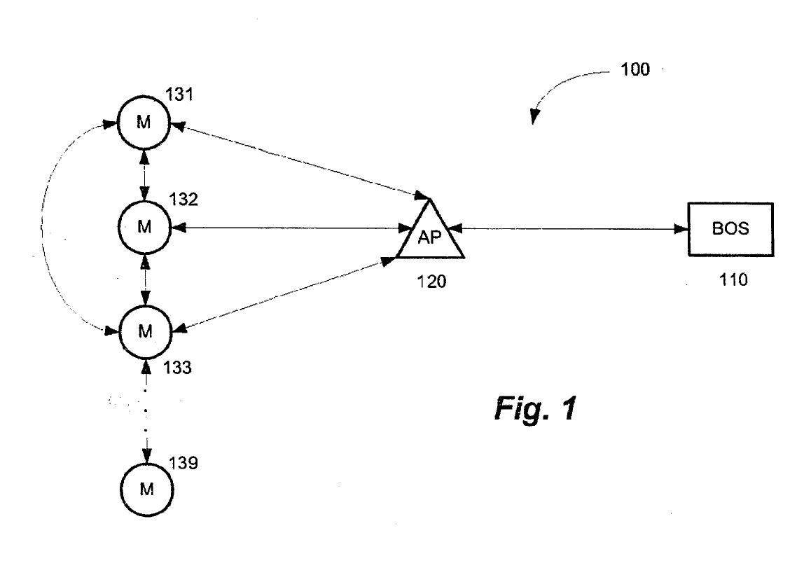

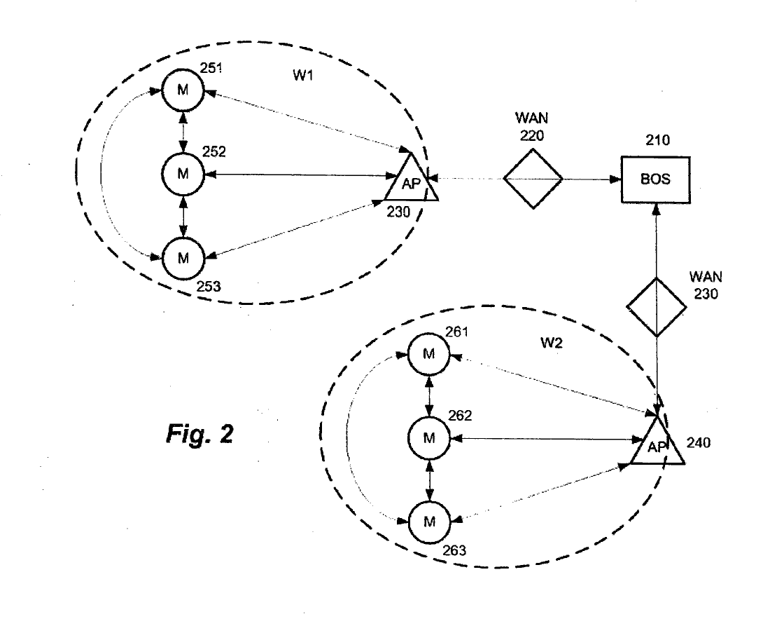

An exemplary embodiment of bulk image downloading is presented for two cases as shown in FIG. 1 and FIG. 2. FIG. 1 is a generic network 100 with a plurality of nodes. A central server (also referred to as Back Office Server or BOS) 110 has two-way communications with a network 100 having a plurality of nodes 131, 132, 133, . . . 139, either directly or via a gateway or access point 120. Normally, any of the nodes might seek access to the BOS 110 via the access point 120, by routing packets in the network through one or more neighbor nodes, and in some cases directly. In accordance with an aspect of the invention, bulk image transfer in a network environment having a plurality of nodes is accomplished by selecting a set of strategically located seed nodes through which the bulk image transfer to all the nodes is accomplished rapidly without consuming valuable network resources (for example, bandwidth) and without disrupting ongoing normal operations.

FIG. 2 depicts a case of multiple wireless networks. Wireless network W1 is connected to a central server (BOS) 210 via a wide-area network (WAN) 220. The nodes 251, 252, 253, . . . of the wireless network W1 maintain two-way access to the BOS via one or more gateways 250. In certain embodiments, the nodes of wireless network W1 may have a direct connection to the BOS 210. Similarly, nodes 261, 262, 263, . . . of a wireless network W2 maintain two-way access to the BOS via WAN 230 and one or more gateways 240. In certain embodiments, the nodes of wireless network W2 may have a direct connection to the BOS 210. In the case of a wireless utility network, the nodes 251, 252, 253, . . . , 261, 262, 263 . . . might be endpoints that are each associated with a utility meter M.

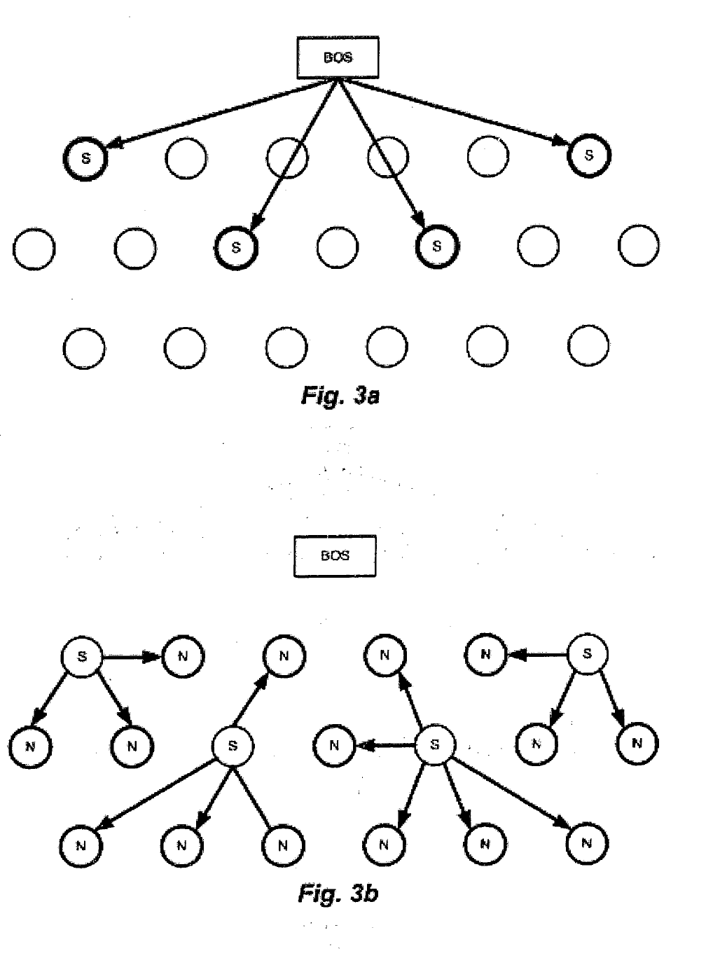

The technique for transferring an image to all of the nodes in networks of the types illustrated in FIGS. 1 and 2 involves two primary phases, represented in FIGS. 3a and 3b. For ease of illustration, access points and WANs are not depicted in FIGS. 3a and 3b. In the first phase, depicted in FIG. 3a, certain nodes of the network are selected as seed nodes S, and the image is transferred from the BOS, or a resource associated with the BOS, to these seed nodes.

In the second phase, shown in FIG. 3b, the other nodes N of the network are informed that there is an image available for them (either by the BOS, the seed node S, or another node N), and are instructed to retrieve the image. In response, these other nodes N locate a seed node S that contains the image, either directly or through a neighboring node, and acquire the image from the seed node.

When transferring relatively large images (e.g., firmware upgrades), the methods described in the '741 Patent can still consume large amounts of network bandwidth. In some instances, the network may include nodes which have different hardware and/or firmware, requiring multiple images to be seeded and disseminated, even though the nodes are all on the same network, and/or geographically near each other. In such cases, additional overhead is required to enable nodes N and/or seeds S to determine which image is the correct image for the node N. For example, an electric utility may provide some neighborhoods with first electric meters, and at a later date, switch meter suppliers and provide second electric meters to other neighborhoods. These neighborhoods can be closely situated, resulting in “islands” of first meters surrounded by areas of second meters.

The need to transfer multiple versions of potentially relatively large images can result in consumption of even greater amounts of network bandwidth, reducing performance of the network. Embodiments of the present invention improve performance of the network by transferring “patch images.” Patch images include the section of firmware (or other program/data stored in memory) that is being updated, and possibly some additional code as needed (e.g., to complete memory blocks, to complete a subsection of the code, etc.), but does not include the entire firmware image. In most instances, patch images are significantly smaller than the entire firmware image. For example, in an extreme circumstance, the patch image can be a single byte, while the entire firmware image can run to many megabytes. The messages containing the patch image can also contain information regarding where the patch image belongs in the entire firmware image (e.g., an address, an offset, a block boundary, etc.).

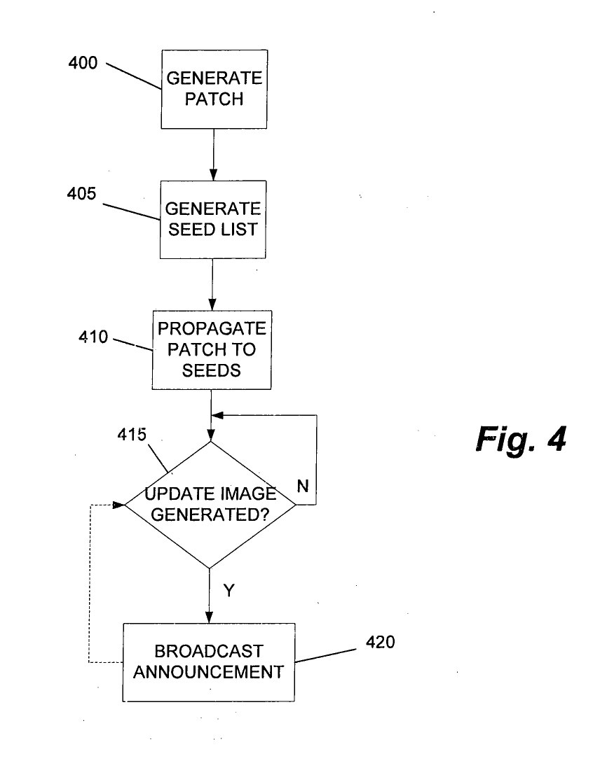

FIG. 4 shows a process for updating devices on a network using patch images. When an update to a firmware image is needed, a patch image is generated (step 400). The image can be generated by the BOS 110/210, or can be generated remotely and supplied to the BOS 110/210. The BOS 110/210 then generates a seed list (step 405) of seed nodes S to receive the patch image. The seed nodes S can be selected as described above. In some embodiments, seed nodes S are also selected based at least in part upon their firmware and/or hardware versions.

Next, the BOS 110/210 transmits a message containing the patch image, along with any overhead information, to the seed nodes S (step 410). The transmission can be a unicast message (i.e., an individual message sent to each seed node individually) or can be a broadcast message (i.e., one message sent to all seed nodes simultaneously). Broadcast messages can include information regarding the type of firmware/hardware the patch image is for, enabling seed nodes S to determine if the message is intended for them.

In the embodiment shown in FIG. 4, after propagating the patch image to the seed nodes S, the BOS 110/210 waits to receive a confirmation from the seed nodes S that they have recreated the entire firmware image. This can be on a network-wide basis or on an individual seed node S basis. In an embodiment employing a network-wide implementation, the BOS 110/210 can wait for all of the seed nodes S to respond that they have recreated the entire image (step 415). In an embodiment employing an individual seed node implementation, the BOS 110/210 can wait for response from individual seed nodes S. Once the response(s) from the seed node(s) are received, the BOS 110/210 can transmit a message to the other nodes N on the network indicating that the image is available. As described below, in some embodiments the seed nodes S push the recreated image to the nodes N near the seed nodes S. In such embodiments, steps 415 and 420 would not necessarily be used.

In an individual node implementation, the BOS 110/210 can return to step 415 to receive responses from additional seed nodes S that they have recreated the firmware image. In some embodiments, the seed nodes S provide the patch image to the non-seed nodes N, which then generate the complete image individually.

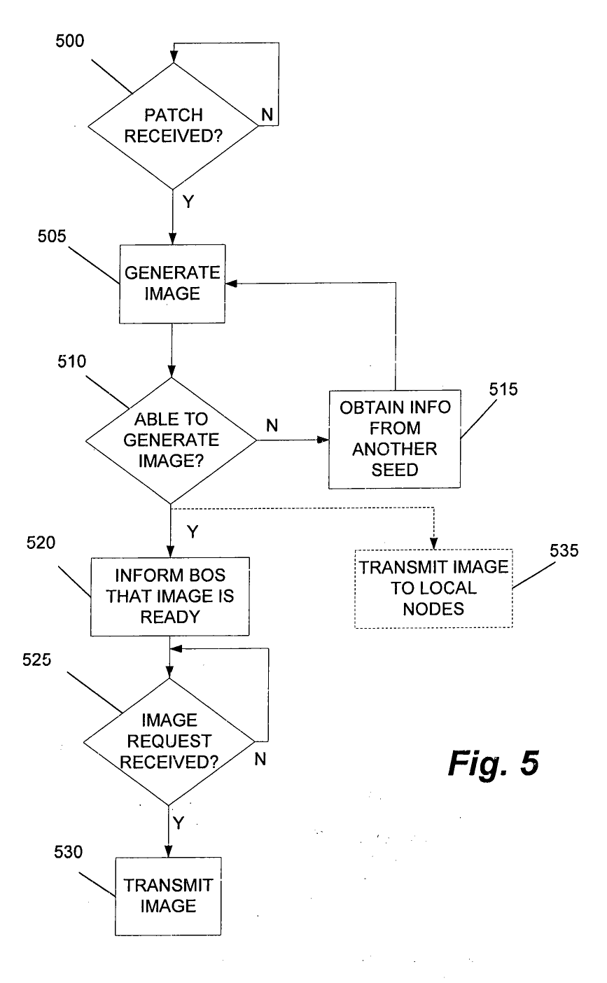

FIG. 5 shows a process for a seed node S for updating devices on a network using patch images. The seed node S can first determine if a patch has been received from the BOS 110/210 (step 500). If a patch image is received, the seed node S generates the full image (step 505). Next, the seed node S determines if the seed node is able to generate the full image (step 510). If the seed node S is unable to generate the full image (e.g., there was a communication error in receiving the patch image), the seed node S can find another seed node S, and can obtain the patch image from that seed node S (step 515) to attempt to generate the full image (step 505) again.

Once the seed node S has generated the full image, the seed node S sends a communication to the BOS 110/210 that the full image has been generated (step 520). Then, while the BOS 110/210 informs other nodes N on the network that the full image is available, the seed node S waits to receive a request for the full image from another node N (step 525). When a request is received, the seed node S transmits the full image to the requesting node N (step 530).

In some embodiments, the seed node S does not recreate the full image, instead the seed node S transmits the patch image to the other nodes N, and the other nodes N each recreate the full image on their own.

In an alternative embodiment, the seed node S pushes the regenerated full image to other nodes N on the network. After the full image is determined to be ready (step 510), the seed node S transmits (via unicast or broadcast messages) the full image to nodes N in its area (step 530).

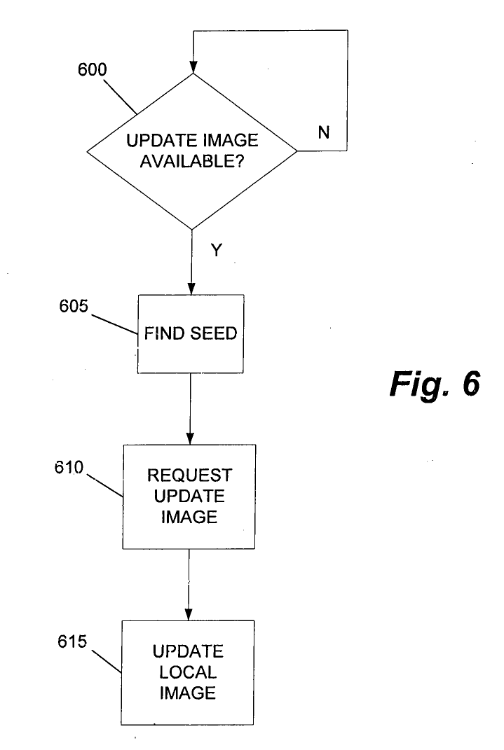

FIG. 6 shows a process for updating a node N on a network. The node N can first receive a message from the BOS 110/210 that an update image is available (step 600). The node N then locates a seed node S having the update image (step 605). Once the seed node S is located, the node N requests the update image from the seed node S (step 610). The node N then receives the update image from the seed node S, and updates its firmware image (step 615).

As described in the '741 Patent, the node N looks for the update image in a plurality of neighbor nodes, requesting the update image from a successively larger number of neighbor nodes N when the update image is not located at one of the neighbor nodes N.

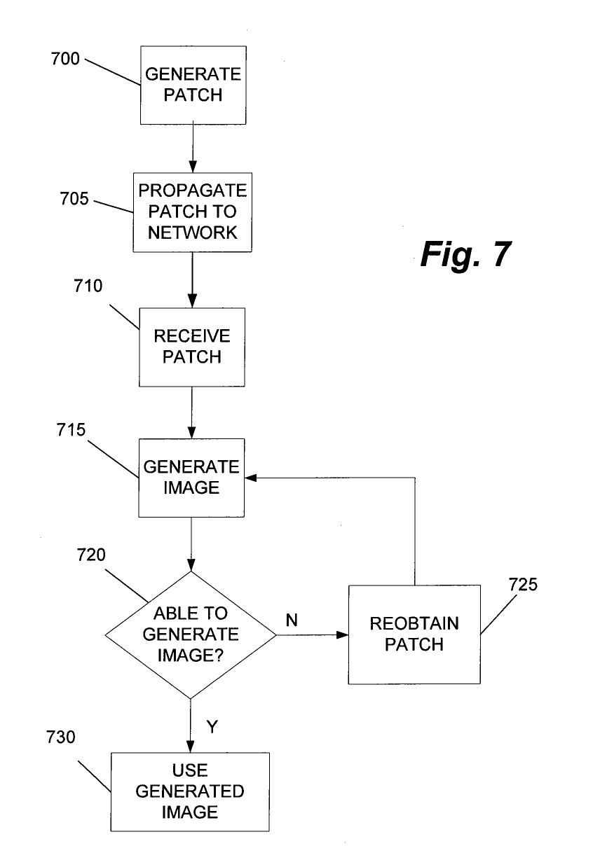

FIG. 7 shows an alternative process for updating devices on a network using patch images. When an update to a firmware image is needed, a patch image is generated (step 700). The image can be generated by the BOS 110/210 or can be generated remotely and supplied to the BOS 110/210. Next, the BOS 110/210 transmits a message containing the patch image, along with overhead information, to the networks W1, W2, etc. (step 705). The transmission can be a unicast message (i.e., an individual message sent to each device M individually) or can be a broadcast message (i.e., one message sent to all the devices M simultaneously). The broadcast message can include information on the type of firmware/hardware the patch image is for, enabling devices M to determine if the message is intended for them.

The devices M determine if a patch has been received from the BOS 110/210 (step 710). If a patch image intended for the device M is received, the device M generates the full image (step 715). Next the device M determines if it is able to generate the full image (step 720). If the device M is unable to generate the full image (e.g., there was a communication error in receiving the patch image), the device M finds another device M (or the BOS 110/210) that has the patch, and obtains the patch image from that device M (step 725). The device M then attempts to generate the full image (step 720) again. Once the device M has generated the full image, the device M begins using the update image (step 730).

In some embodiments, nodes N download the image in chunks from multiple seed nodes S, thereby speeding up the download process.

Various features and advantages of the invention are set forth in the following claims.

What is claimed is:

1. A method of distributing information to a plurality of nodes in a network, the method comprising:
selecting a node of the plurality of nodes as a seed node;
providing a patch image to the seed node;
creating, by the seed node, a second image from the patch image; and
disseminating the second image to a plurality of neighbor nodes.

2. The method of claim 1, further comprising sending, by the seed node, an indication that the second image has been created.

3. The method of claim 2, further comprising sending a notification message from a central location that the seed node has the second image available.

4. The method of claim 1, further comprising sending an information transfer request from each non-seed node to an established number of neighbor nodes.

5. The method of claim 4, further comprising sending the information transfer request to a successively larger number of neighbor nodes when the second image is not located at one of the neighbor nodes.

6. The method of claim 1, wherein the second image is a complete firmware image, and the patch image is substantially smaller than the second image.

7. The method of claim 1, wherein the seed node pushes the second image to a plurality of neighbor nodes.

8. The method of claim 1, wherein the plurality of nodes are electric utility meters.

9. The method of claim 1, wherein the second image is the patch image, the plurality of nodes creating a complete image from the second image.

10. The method of claim 1, wherein the second image is a firmware image.

11. The method of claim 1, wherein a non-seed node obtains portions of the second image from a plurality of seed nodes.

12. A method of distributing information to a plurality of nodes in a network, the method comprising:
receiving a first patch image by a first node of the plurality of nodes, the first node having a first firmware type;
building, by the first node, a first complete image using the first patch image;
informing the plurality of nodes that the first complete image is available;
receiving a request for the first complete image from another of the plurality of nodes; and
sending the first complete image from the first node to the node which requested the first complete image.

13. The method of claim 12, wherein the informing the plurality of nodes that the first complete image is available includes the first node communicating that the first complete image is ready to a central location, and the central location broadcasting to the plurality of nodes that the first node has the first complete image.

14. The method of claim 13, wherein the central location is a back office system.

15. The method of claim 12, further comprising
receiving a second patch image by a second node of the plurality of nodes, the second node having a second firmware type;
building, by the second node, a second complete image using the second patch image;
informing the plurality of nodes that the second complete image is available;
receiving a request for the second complete image from another of the plurality of nodes; and
sending the second complete image from the second node to the node which requested the second complete image.

16. The method of claim 13, wherein the informing the plurality of nodes that the second complete image is available includes the second node communicating that the second complete image is ready to a central location, and the central location broadcasting to the plurality of nodes that the second node has the second complete image.

17. The method of claim 16, wherein the broadcast includes an indication that the second complete image is for nodes having the second firmware type.

18. The method of claim 12, wherein informing the plurality of nodes that the first complete image is available is accomplished by the first node communicating the availability of the first complete image to a plurality of neighbor nodes.

19. A method of updating a network having nodes with two or more incompatible firmware types, the method comprising:
selecting a first node in the network having a first firmware-type as a first seed node;
selecting a second node in the network having a second firmware-type as a second seed node;
providing a first firmware-type patch image to the first node;
providing a second-firmware-type patch image to the second node;
recreating, by the first node, a first firmware-type complete image;
recreating, by the second node, a second firmware-type complete image;
disseminating, by the first node, the first firmware-type complete image to a first plurality of nodes on the network having the first firmware-type; and
disseminating, by the second node, the second firmware-type complete image to a second plurality of nodes on the network having the second firmware-type.

20. The method of claim 19, further comprising informing, by the first node, a central location that the first firmware-type complete image has be recreated, and broadcasting, by the central location, to the network that the first firmware-type complete image is available.

21. The method of claim 20, further comprising informing, by the second node, the central location that the second firmware-type complete image has be recreated, and broadcasting, by the central location, to the network that the second firmware-type complete image is available.
